(19) United States
(12) Patent Application Publication
(10) Pub. No.: US 2019/0347721 A1
(43) Pub. Date: Nov. 14, 2019

(54) FINANCIAL PROCESSING SYSTEM AND METHOD FOR LENDER BASED PROVISION OF FINANCIAL ASSET

(71) Applicant: Tushar AGGARWAL, Green Cove Springs, FL (US)

(72) Inventor: Tushar AGGARWAL, Green Cove Springs, FL (US)

(21) Appl. No.: 15/979,293

(22) Filed: May 14, 2018

(51) Int. Cl. G06Q 40/02; G06Q 50/26

(52) U.S. Cl. CPC G06Q 40/025; G06Q 50/265

(57) ABSTRACT

The present disclosure provides a method and system for providing a financial asset to a user from at least one lender based on the profile of the user. The system executes instructions to cause one or more processors to perform a method. The method includes receiving a first set of data and verifying the first set of data. In addition, the method includes collecting a second set of data and verifying the second set of data. Further, the method includes gathering a third set of data and verifying the third set of data. Furthermore, the method includes creating the profile of the user and obtaining a fourth set of data from a plurality of lenders. Also, the method includes mapping the data of the profile of the user with the fourth set of data and providing financial asset to the user based on the mapping.

### TECHNICAL FIELD

The present disclosure relates to a field of financial processing system. More specifically, the present disclosure relates to a method and system for providing financial asset to a user from at least one lender based on a profile of a user.

### BACKGROUND

Financial institutions provide financial asset to individuals, businesses and the like. The financial asset includes personal loan, home loan, student loan, business loan, credit cards, and the like. Generally, the financial institutions receive a request from a borrower for borrowing the financial asset. The financial institutions perform a background check of the borrower for verification. The verification is performed to identify if the borrower is capable of repaying the financial asset. The background check is performed based on the limited personal and banking information furnished with the request for the financial asset. The financial asset is approved by the financial institutions for the borrower after verifying the borrower. Sometimes, the borrower provides fabricated information in order to get the financial asset. The fabricated information provided by the borrower passes the background check performed by the financial institutions. The background check performed by the financial institution does not prove to be effective for identifying if a person is capable to repay the financial asset. The background check performed by the financial institution is limited to the information provided by the borrower. In many cases, the financial institutions have to resort to other means for compensating for the amount associated with the financial asset. In one example, the financial institutions seize property or any other tangible asset of the borrower for repayment of the financial asset. There is a constant need to improve the verification process for avoiding loss incurred by the financial institutions.

### SUMMARY

In a first example, a computer-implemented method is provided. The computer-implemented method is for providing a financial asset to a user from at least one lender based on a profile of the user. The computer-implemented method may include a first step of receiving a first set of data associated with demographic information of the user. In addition, the computer-implemented method may include another step of verifying the first set of data associated with the user. The verification of the first set of data is done by mapping the demographic information of the user with the data of the user available on one or more web-based platforms. The computer-implemented method may include yet another step of collecting a second set of data associated with professional information of the user. In addition, the computer-implemented method may include yet another step of verifying the second set of data associated with the user. The verification of the second set of data is done by mapping the professional information of the user with the data of the user available on one or more web-based platforms. The computer-implemented method may include yet another step of gathering a third set of data associated with banking information of the user. The computer-implemented method may include yet another step of verifying the third set of data associated with the user. The verification of the third set of data is done by mapping the banking information of the user with the data of the user available on one or more web-based platforms. The computer-implemented method may include yet another step of creating a profile of the user based on the accuracy of the first set of data, the second set of data and the third set of data. The computer-implemented method may include yet another step of obtaining the fourth set of data associated with a plurality of lenders. The computer-implemented method may include yet another step of mapping the data of the profile of the user with the fourth set of data of the plurality of lenders. The mapping is done to select the at least one lender from the plurality of lenders for providing the financial asset to the user. Further, the system includes the signal generator circuitry embedded inside the first portable communication device to trigger one or more hardware components associated with the first portable communication device. The computer-implemented method may include yet another step of providing the financial asset to the user from the at least one lender based on the mapping of the profile of the user with the fourth set of data of the at least one lender. In addition, the computer-implemented method provides the financial asset to the user after verification of the user. The demographic information of the user is received when the signal generator circuitry embedded inside the portable communication device generates a signal to open a first page on the first mobile application. The first page is open on the first mobile application to receive inputs from the user regarding demographic information. In addition, the verification of the first set of data is done in real time. The professional information of the user is collected when the signal generator circuitry embedded inside the portable communication device generates a signal to open a second page on the first mobile application. The second page is open on the first mobile application to collect inputs from the user regarding professional information. In addition, the verification of the second set of data is done in real time. The banking information of the user is gathered when the signal generator circuitry embedded inside the portable communication device generates a signal to open a third page on the first mobile application. The third page is open on the first mobile application to gather inputs from the user regarding banking information. In addition, the verification of the third set of data is done in real time. The accuracy of the first set of data, the second set of data and the third set of data is determined by verifying the first set of data, the second set of data and the third set of data in real time. The verification is done by mapping the first set of data, the second set of data and the third set of data with the data of the user available on the one or more web-based platforms. The profile of the user is used to decide the minimum amount of the financial asset to be rendered to the user. The fourth set of data is obtained in real-time. The one or more hardware components are triggered for verification of the user.

In an embodiment of present disclosure, the first set of data includes the demographic information of the user. The demographic information includes name, last name, age, gender, father name, mother name, mobile number, address, e-mail address, education, nationality, number and type of devices associated with the user.

In an embodiment of present disclosure, the second set of data includes the professional information of the user. The professional information includes occupation, company details, salary details, experience, pan card details, aadhaar card details, and passport availability.

In an embodiment of present disclosure, the third set of data includes the banking information of the user. The banking information includes account details, number of bank accounts associated with the user, number of credit card and debit cards accessed by the user, amount of financial asset required by the user. In addition, the banking information includes preference of the mode of transfer of the financial asset from the at least one lender, preference of the user in the rate of interest and time duration of repayment of the financial asset.

In an embodiment of present disclosure, the fourth set of set of data associated with the plurality of lenders includes the information regarding rate of interest, time, and minimum amount of the financial asset rendered by the plurality of lenders. In addition, the fourth set of data includes one or more terms and conditions of the plurality of lenders to provide financial asset.

In an embodiment of present disclosure, the one or more hardware components are triggered to obtain the real-time data from the user for verification of the user. The one or more hardware components comprise a front camera, a rear camera, a mic and a speaker of the portable communication device.

In an embodiment of present disclosure, the computer-implemented method may include yet another step of analyzing the first set of data, the second set of data and the third set of data with past user data stored in the database. In addition, the past user data is used to identify the user pattern. Further, the user pattern is identified to analyze the user behavior for repayment of the financial asset. Moreover, the analyzing is done by using machine learning algorithms in real time.

In an embodiment of present disclosure, the computer implemented-method may include yet another step of storing the first set of data, the second set of data, the third set of data and the fourth set of data, wherein the storing is done in real time.

In an embodiment of present disclosure, the computer implemented-method may include yet another step of updating the first set of data, the second set of data, the third set of data and the fourth set of data, wherein the updating is done in real time.

In an embodiment of the present disclosure, the one or more hardware components are triggered after acceptance of request by the at least one lender to provide the financial asset to the user.

In a second example, a computer system is provided. The computer system may include one or more processors and a memory coupled to the one or more processors. The memory may store instructions which, when executed by the one or more processors, may cause the one or more processors to perform a method. The method for providing financial asset to a user from at least one lender based on a profile of the user. The method may include a first step of receiving a first set of data associated with demographic information of the user. In addition, the method may include another step of verifying the first set of data associated with the user. The verification of the first set of data is done by mapping the demographic information of the user with the data of the user available on one or more web-based platforms. The method may include yet another step of collecting a second set of data associated with professional information of the user. In addition, the method may include yet another step of verifying the second set of data associated with the user. The verification of the second set of data is done by mapping the professional information of the user with the data of the user available on the one or more web-based platforms. The method may include yet another step of gathering a third set of data associated with banking information of the user. The method may include yet another step of verifying the third set of data associated with the user. The verification of the third set of data is done by mapping the banking information of the user with the data of the user available the on one or more web-based platforms. The method may include yet another step of creating a profile of the user based on the accuracy of the first set of data, the second set of data and the third set of data. The method may include yet another step of obtaining the fourth set of data associated with a plurality of lenders. The method may include yet another step of mapping the data of the profile of the user with the fourth set of data of the plurality of lenders. The mapping is done to select the at least one lender from the plurality of lenders for providing the financial asset to the user. Further, the system includes the signal generator circuitry embedded inside the first portable communication device to trigger one or more hardware components associated with the first portable communication device. The method may include yet another step of providing the financial asset to the user from the at least one lender based on the mapping of the profile of the user with the fourth set of data of the at least one lender. In addition, the system provides the financial asset to the user after verification of the user. The demographic information of the user is received when the signal generator circuitry embedded inside the portable communication device generates a signal to open a first page on the first mobile application. The first page is open on the first mobile application to receive inputs from the user regarding demographic information. In addition, the verification of the first set of data is done in real time. The professional information of the user is collected when the signal generator circuitry embedded inside the portable communication device generates a signal to open a second page on the first mobile application. The second page is open on the first mobile application to collect inputs from the user regarding professional information. In addition, the verification of the second set of data is done in real time. The banking information of the user is gathered when the signal generator circuitry embedded inside the portable communication device generates a signal to open a third page on the first mobile application. The third page is open on the first mobile application to gather inputs from the user regarding banking information. In addition, the verification of the third set of data is done in real time. The accuracy of the first set of data, the second set of data and the third set of data is determined by verifying the first set of data, the second set of data and the third set of data in real time. The verification is done by mapping the first set of data, the second set of data and the third set of data with the data of the user available on the one or more web-based platforms. The profile of the user is used to decide the minimum amount of the financial asset to be rendered to the user. The fourth set of data is obtained in real-time. The one or more hardware components are triggered for verification of the user.

In a third example, a computer-readable storage medium is provided. The computer-readable storage medium encodes computer executable instructions that, when executed by at least one processor, performs a method. The method for providing the financial asset to a user from at least one lender based on a profile of the user. The method may include a first step of receiving a first set of data associated with demographic information of the user. In addition, the method may include another step of verifying the first set of data associated with the user. The verification of the first set of data is done by mapping the demographic information of the user with the data of the user available on one or more web-based platforms. The method may include yet another step of collecting a second set of data associated with professional information of the user. In addition, the method may include yet another step of verifying the second set of data associated with the user. The verification of the second set of data is done by mapping the professional information of the user with the data of the user available on the one or more web-based platforms. The method may include yet another step of gathering a third set of data associated with banking information of the user. The method may include yet another step of verifying the third set of data associated with the user. The verification of the third set of data is done by mapping the banking information of the user with the data of the user available on the one or more web-based platforms. The method may include yet another step of creating a profile of the user based on the accuracy of the first set of data, the second set of data and the third set of data. The method may include yet another step of obtaining the fourth set of data associated with a plurality of lenders. The method may include yet another step of mapping the data of the profile of the user with the fourth set of data of the plurality of lenders. The mapping is done to select the at least one lender from the plurality of lenders for providing the financial asset to the user. Further, the system includes the signal generator circuitry embedded inside the first portable communication device to trigger one or more hardware components associated with the first portable communication device. The method may include yet another step of providing the financial asset to the user from the at least one lender based on the mapping of the profile of the user with the fourth set of data of the at least one lender. In addition, the system provides the financial asset to the user after verification of the user. The demographic information of the user is received when the signal generator circuitry embedded inside the portable communication device generates a signal to open a first page on the first mobile application. The first page is open on the first mobile application to receive inputs from the user regarding demographic information. In addition, the verification of the first set of data is done in real time. The professional information of the user is collected when the signal generator circuitry embedded inside the portable communication device generates a signal to open a second page on the first mobile application. The second page is open on the first mobile application to collect inputs from the user regarding professional information. In addition, the verification of the second set of data is done in real time. The banking information of the user is gathered when the signal generator circuitry embedded inside the portable communication device generates a signal to open a third page on the first mobile application. The third page is open on the first mobile application to gather inputs from the user regarding banking information. In addition, the verification of the third set of data is done in real time. The accuracy of the first set of data, the second set of data and the third set of data is determined by verifying the first set of data, the second set of data and the third set of data in real time. The verification is done by mapping the first set of data, the second set of data and the third set of data with the data of the user available on the one or more web-based platforms. The profile of the user is used to decide the minimum amount of the financial asset to be rendered to the user. The fourth set of data is obtained in real-time. The one or more hardware components are triggered for verification of the user.

### BRIEF DESCRIPTION OF FIGURES

Having thus described the invention in general terms, reference will now be made to the accompanying drawings, which are not necessarily drawn to scale, and wherein:

FIG. 1 illustrates an interactive computing environment for providing a financial asset to a user from at least one lender based on the profile of the user, in accordance with various embodiments of the present disclosure;

FIG. 2A and FIG. 2B illustrates a flowchart for providing financial asset to the user from the at least one lender based on the profile of the user, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology. Reference in this specification to “one embodiment” or “an embodiment” means that a particular feature, structure, or characteristic described in connection with the embodiment is included in at least one embodiment of the present technology.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

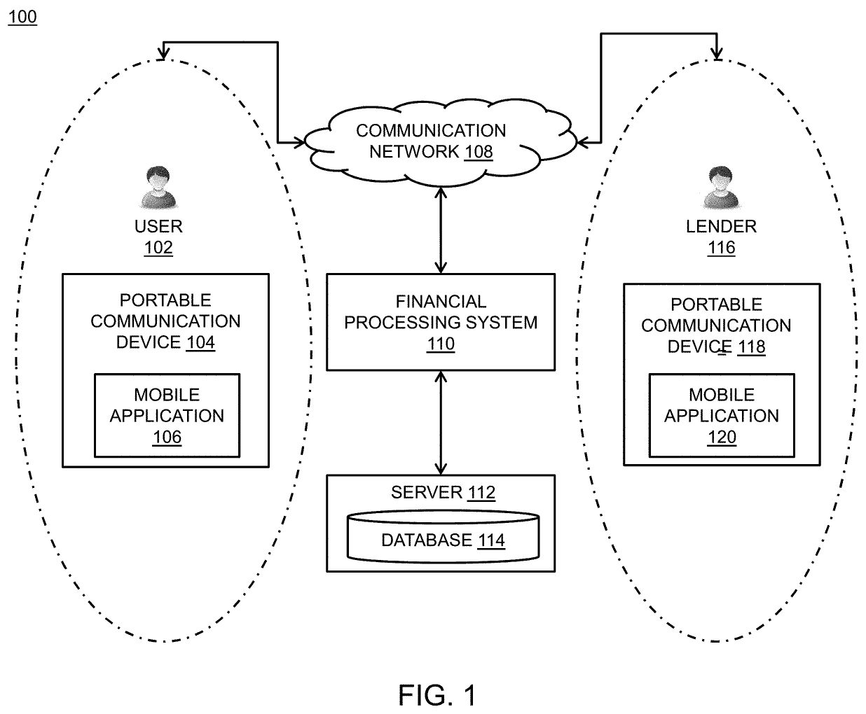

FIG.1 illustrates an interactive computing environment 100 for providing a financial asset to a user 102 from at least one lender 120, in accordance with various embodiments of the present disclosure. The interactive computing environment 100 includes the user 102, a first portable communication device 104, a first mobile application 106 and a signal generator circuitry 108. In addition, the interactive computing environment 100 includes one or more hardware components 110, a communication network 112 and a financial processing system 114. Further, the interactive computing environment 100 includes a server 116, a database 118, the at least one lender 120, a second portable communication device 122 and a second mobile application 124. The above-stated elements of the interactive computing environment collectively enable the financial processing system 114 for providing the financial asset to the user 102 from the at least one lender 120. The lender 120 may be an individual or a financial institution such as a bank. In the case of a bank, the lender 120 may be a person in charge of handling requests for financial assets from users.

In an embodiment of the present disclosure, the interactive computing environment 100 includes the user 102. The user 102 may be any person or an individual looking for the financial asset through one or more financial asset providing platforms. In addition, the user 102 may be any person or an individual looking for the minimum amount of the financial asset through the one or more financial providing platforms. In an example, a plurality of lenders is associated with the one or more financial providing platforms. In an embodiment of the present disclosure, the user 102 is associated with the first portable communication device 104. In an example, the user 102 is an owner of the first portable communication device 104. In another example, the user 102 may not be the owner of the first portable communication device 104.

In an example, the first portable communication device 104 includes but may not be limited to a laptop, a smartphone and a tablet. The user 102 may access the first portable communication device 104 while moving from one place to another place. In an example, the place includes home, park, restaurant, any facility, college, office and the like. In addition, the user 102 may access the first portable communication device 104 from inside and outside of the environment.

In general, the portable communication devices are used for one or more purposes. In an example, the one or more purposes include communication, entertainment, accessing web-based platforms for different tasks and the like. In an embodiment of the present disclosure, the first portable communication device 104 includes the first mobile application 106. The first mobile application 106 is installed on the first portable communication device 104. In general, the mobile application performs various tasks such as handling notifications and connectivity. Also, the mobile application is programmed in different languages for different platforms. Moreover, the use of the mobile application in online mode and offline mode depends on the type of application used. In an example, the mobile applications are used for entertaining, productivity, marketing and accessing various e-commerce and web-based platforms.

In an embodiment of the present disclosure, the first mobile application 106 is associated with the financial asset providing platform. In addition, the first mobile application 106 is used to access the financial asset providing platform. In an example, the financial asset includes but not limited to personal loan, student loan, business loan, money, car loan and home loan. The financial asset providing platform provides the financial asset to the user 102 based on the requirement of the financial asset to the user 102. Further, the financial asset providing platform provides the financial asset to the user 102 after performing one or more steps. In an example, the first mobile application 106 gets active when the first portable communication device 104 is connected to the internet.

In an embodiment of the present disclosure, the first portable communication device 104 is connected to the internet in real time. Further, the first portable communication device 104 is associated with a specific type of operating system. The specific type of operating system includes an android operating system, a windows operating system, a mac operating system and the like. Moreover, the first portable communication device 104 is connected to the internet through the communication network 112. Further, the first portable communication device 104 is connected to the internet through a data connection provided by a telecom service provider. The telecom service provider is associated with a subscriber identification module card located inside the first portable communication device 104. Furthermore, the first portable communication device 104 may be connected to the internet through a WiFi connection.

In an embodiment of the present disclosure, the first portable communication device 104 is associated with the financial processing system 114. In addition, the first portable communication device 104 is associated with the financial processing system 114 through the communication network 112. In an embodiment of the present disclosure, the communication network 112 enables the first portable communication device 104 to gain access to the internet. Moreover, the first portable communication device 104 provides a medium for transferring of information between the first portable communication device 104 and the financial processing system 114. Further, the medium for communication may be infrared, microwave, radio frequency (RF) and the like. The communication network 112 includes but may not be limited to a local area network, a metropolitan area network, a wide area network and a virtual private network. In addition, the communication network 112 includes but may not be limited to a global area network, a home area network or any other communication network presently known in the art. The communication network 112 is a structure of various nodes or communication devices connected to each other through a network topology method. Examples of the network topology include a bus topology, a star topology, a mesh topology and the like.

The interactive computing environment 100 includes the financial processing system 114. In an embodiment of the present disclosure, the financial processing system 114 receives a first set of data. The first set of data is associated with demographic information of the user 102. The demographic information of the user 102 is received when the signal generator circuitry 108 embedded inside the first portable communication device 104 generates a signal to open a first page on the first mobile application 106. The first page is opened in the first mobile application 106 to receive inputs from the user 102 associated with the demographic information. In addition, the time to open the first page depends on the connectivity of the first portable communication device 104 with the communication network 112. The signal generator circuitry 108 embedded inside the first portable communication device 104 generates the signal to open the first page based on the strength of communication network 112. In an example, the communication network 112 is accessed through a network antenna present inside the first portable communication device 104. In general, the signal generator circuitry 108 generate signals to trigger the one or hardware components 110 associated with the first portable communication device 114. The one or more hardware components 110 are triggered for one or more purposes. The one or more purposes include but may not limited to inform user to enter information, to open pages to receive information and to indicate the user has entered wrong data. In addition, the one or more purposes include indication of the successful completion of the financial asset, indicate the eligibility of the user and verify the user based on the re e data of the user.

The first set of data includes the demographic information of the user 102. In an embodiment of the present disclosure the demographic information includes name, last name, age, gender, father name, mother name, mobile number, address and e-mail address. In addition, the demographic information includes education, nationality, number and type of devices associated with the user and the like. In another embodiment of the present disclosure, the demographic information includes any other suitable information required for providing financial asset to the user 102. Further, the financial processing system 114 verifies the first set of data associated with the user 102.

In an embodiment of the present disclosure, the financial processing system 114 verifies the first set of data by mapping the demographic information of the user 102 with the data of the user 102 available on one or more web-based platforms. In an example, the one or more web-based platforms include social network platform, e-commerce platform and the like. In addition, the data of the user 102 available on the one or more web-based platforms may include information of the user 102 available on the one or more social networking platforms. In an example, the social networking platform includes Facebook, Instagram, LinkedIn, Orkut and the like. In an embodiment of the present disclosure, the data available on the one or more web-based platforms is the data of the user filled by the user 102 in past time. In an example, the user 102 updates the data on the one or more web based platforms on a regular basis. Thus, the financial processing system 114 verifies the first set of data after receiving the first set of data from the user 102.

In an embodiment of the present disclosure, the financial processing system 114 collects a second set of data. The second set of data is associated with professional information of the user 102. The professional information of the user 102 is collected when the signal generator circuitry 108 embedded inside the first portable communication device 104 generates a signal to open a second page on the first mobile application 106. The second page is opened in the first mobile application 106 to collect inputs from the user 102 regarding professional information. In addition, the second page is open in the first mobile application 106 after receiving and verifying the first set of data. Further, the time to open the second page depends on the connectivity of the first portable communication device 104 with the communication network 112. The signal generator circuitry 108 embedded inside the first portable communication device 104 generates the signal to open the second page based on the strength of communication network 112. In an example, the communication network 112 is accessed through a network antenna present inside the first portable communication device 104.

The second set of data includes the professional information of the user 102. In an embodiment of the present disclosure, the professional information includes occupation, company details, salary details, experience and passport availability. In another embodiment of the present disclosure, the professional information includes any other suitable information required for providing the financial asset to the user 102. Further, the financial processing system 114 verifies the second set of data associated with the user 102.

In an embodiment of the present disclosure, the financial processing system 114 verifies the second set of data by mapping the professional information of the user 102 with the data of the user 102 available on the one or more web-based platforms. In an example, the one or more web-based platforms include social network platform, e-commerce platform and the like. In addition, the data of the user 102 available on the one or more web-based platforms may include information of the user 102 on the one or more social networking platforms. In an example, the social networking platform includes Facebook, Instagram, LinkedIn, Orkut and the like. In an embodiment of the present disclosure, the data available on the one or more web-based platforms is the data of the user 102 filled by the user 102 in past time. In an example, the user 102 updates the data on the one or more web based platforms on a regular basis. Thus, the financial processing system 114 verifies the second set of data after collecting the second set of data from the user 102.

In an embodiment of the present disclosure, the financial processing system 114 gathers a third set of data. The third set of data is associated with banking information of the user 102. The banking information of the user 102 is gathered when the signal generator circuitry 108 embedded inside the first portable communication device 102 generates a signal to open a third page on the first mobile application 106. The third page is opened in the first mobile application 106 to gather inputs from the user 102 regarding the banking information. In addition, the time to open the third page depends on the connectivity of the first portable communication device 104 with the communication network 112. The signal generator circuitry 108 embedded inside the first portable communication device 104 generates the signal to open the third page based on the strength of the communication network 112. In addition, the signal generator circuitry 108 embedded inside the first portable communication device 104 generates the signal to open the third page after successful verification of the second set of data. Further, the signal generator circuitry 108 embedded inside the first portable communication device 104 generates the signal to open the third page based on the strength of the communication network 112. In an example, the communication network 112 is accessed through a network antenna present inside the first portable communication device 104.

The third set of data includes the banking information of the user 102. In an embodiment of the present disclosure, the banking information includes bank account details, number of bank accounts associated with the user 102, number of credit cards and debit cards accessed by the user 102. In addition, the banking information includes the amount of the financial asset required by the user 102, preference of the mode of transfer of the financial asset from the at least one lender 120. Further, the banking information includes preference of the user 102 for rate of interest and time duration of repayment of the financial asset. In another embodiment of the present disclosure, the banking information includes any other suitable information required for providing the financial asset to the user 102.

In an embodiment of the present disclosure, the financial processing system 114 verifies the third set of data by mapping the banking information of the user 102 with the data of the user available on the one or more web-based platforms. In an example, the one or more web-based platforms include social network platform, e-commerce platform and the like. In addition, the data of the user 102 available on the one or more web-based platforms may include information of the user 102 available on the one or more social networking platforms. In an example, the social networking platform includes Facebook, Instagram, LinkedIn, Orkut and the like. In an embodiment of the present disclosure, the data available on the one or more web-based platforms is the data of the user 102 filled by the user 102 in past time. In an example, the user 102 updates the data on the one or more web-based platforms on a regular basis. Thus, the financial processing system 114 verifies the third set of data in real time after gathering the third set of data from the user 102.

In an embodiment of the present disclosure, the financial processing system 114 may ask the user 102 to upload one or more documents associated with the identity of the user 102. The user 102 may upload the one or more documents on the first mobile application 106 while providing the first set of data, the second set of data and the third set of data. In an example, the user 102 uploads softcopy of mark sheet, birth certificate and the like.

In an embodiment of the present disclosure, the financial processing system 114 analyzes the first set of data, the second set of data and the third set of data. The first set of data, the second set of data and the third set of data is analyzed with past user data stored in the database 118. In addition, the past user data is used to identify the user pattern. Further, the user pattern is identified to analyze the user behavior for repayment of the financial asset. Furthermore, the analyzing of the first set of data, the second set of data and the third set of data is done by using machine learning algorithms in real time. Also, the financial processing system 114 analyzes the first set of data, the second set of data and the third set of data to create a profile of the user 102. In an example, the financial processing system 114 analyzes the first set of data, the second set of data and the third set of data by mapping the similarities in between the profile data of the user 102 with the stored data of the past users. In an example, the financial processing system 114 analyzes the data associated with a plurality of users. The financial processing system 114 classifies the plurality of users based on the data associated with the repayment of the financial asset by the plurality of users. The financial processing system 114 creates a cluster of similar users and identifies the pattern from the data of the similar users. The pattern helps in determining the behavior of the user 102 for the repayment of the financial asset. Thus, the financial processing system 114 uses the past user data for analyzing the first set of data, the second set of data and the third set of data.

In an embodiment of the present disclosure, the financial processing system 114 creates a profile of the user 102 based on the accuracy of the first set of data, the second set of data and the third set of data. In addition, the accuracy of the first set of data, the second set of data and the third set of data is determined by verifying and analyzing the first set of data, the second set of data and the third set of data in real time. Further, the profile of the user 102 is used to decide the minimum amount of the financial asset which may be rendered to the user 102.

In an embodiment of the present disclosure, the financial processing system 114 obtains a fourth set of data associated with a plurality of lenders. In an example, the financial processing system 114 obtains the fourth set of data associated with the plurality of lenders from the database 118. In another example, the financial processing system 114 obtains the fourth set of data associated with the plurality of lenders through the plurality of portable communication devices in real time. In general, the plurality of lenders lends the financial asset to the users based on one or more terms and conditions. In an example, the one or more terms and conditions include rate of interest, time duration, amount of financial asset and the like. Further, the plurality of lenders includes individual, person, bank, a public group, a private group or a financial institution. Moreover, the plurality of lenders provides financial asset to the user 102 with the expectation of that the repayment of the financial asset will be done by the user 102 within a fixed interval of time. Also, the plurality of lenders provides financial asset to the user 102 after performing one or more steps of verification of the details of user 102 to identify the capability of the user 102 to repay the financial asset within the specified time period interval.

In an embodiment of the present disclosure, the fourth set of data includes the information regarding rate of interest, time and minimum amount of the financial asset to be provided by the plurality of lenders. Further, the fourth set of data includes one or more terms and conditions of the plurality of lenders to provide the financial asset to the user 102.

In an embodiment of the present disclosure, the fourth set of data of the plurality of lenders is stored in the database 118 of the server 116. In an example, the financial processing system 114 fetches the fourth set of data from the database 118 for lending the financial asset to the user 102 based on the profile of the user 102. In another embodiment of the present disclosure, the financial processing system 114 obtains the data from the plurality of lenders in real time. In an example, the data obtained from the plurality of lenders through the plurality of portable communication devices associated with the plurality of users. In an embodiment of the present disclosure, the data of the plurality of lenders is obtained to select the at least one lender 120 for providing the financial asset to the user 102. In an example, the at least one lender 120 from the plurality of lenders is selected by the user 102 based on the mapping of the data of the user 102 with the data of the plurality of lenders. In another example, the financial processing system 114 assigns the at least one lender 120 from the plurality of lenders to provide the financial asset to the user 102.

In an embodiment of the present disclosure, the financial processing system 114 maps the data of the profile of the user 102 with the fourth set of data of the plurality of lenders. In addition, the mapping is done to select the at least one lender 120 for providing the financial asset to the user 102. The at least one lender 120 is selected from the plurality of lenders for providing the financial asset to the user 102. In another embodiment of the present disclosure, the user 102 has the option to select the at least one lender 120 from the plurality of lenders based on the mapping of the profile of the user 102 with the fourth set of data of the at least one lender 120. In an example, the financial processing system 114 maps the terms and conditions of the plurality of lenders with the profile of the user 102. Based on the mapping of the profile of the user 102 with the plurality of lenders, the financial processing system 114 assigns the at least one lender 120 to provide the financial asset to the user 102.

In an embodiment of the present disclosure, the at least one lender 120 is selected from the plurality of lenders based on the mapping of the profile of the user 102 with the at least one lender 120. In addition, the at least one lender 120 is selected based on the mapping of the fourth set of data of the at least one lender 120 with the profile of the user 102. In an example, time duration, amount to be lend and the rate of interest associated with the at least one lender 120 matches with the data associated with the profile of the user 102. In another example, the at least one lender 120 selected from the plurality of lenders provides the minimum amount of the financial asset to the user 102 based on the requirement of the financial asset to the user 102.

In an embodiment of the present disclosure, the at least one lender 120 accepts the request for providing the financial asset to the user 102. In an example, the user 102 sends the request to the at least one lender 120 for providing financial asset based on the mapping. In another example, the financial processing system 114 sends the request to the at least one lender 120 to provide the financial asset to the user 102. Further, the request to the at least one lender 120 is sent on the second mobile application 124 of the second portable communication device 122. In an example, the second portable communication device 122 is associated with the at least one lender 120.

In an embodiment of the present disclosure, the at least one lender 120 accepts the request of providing the financial asset to the user 102 in real time. In addition, the financial processing system 114 includes the signal generator circuitry 108. In an example, the signal generator circuitry 108 is embedded inside the first portable communication device 104. Further, the signal generator circuitry 108 triggers the one or more hardware components 110 of the first portable communication device 104 when the at least one lender 120 accept the request of the user 102 for providing the financial asset. The one or more hardware components 110 are triggered for verification of the user 102. In an example, the one or more hardware components 110 are triggered for the final verification of the user 102. In an example, the one or more hardware components 110 include but may not be limited to the front camera, the rear camera, the mic and the speaker.

Further, the one or more hardware components 110 are triggered to obtain the real-time data of the user 102 for the successful verification of the user 102. The financial processing system 114 verifies the real-time data obtained from the one or more hardware components 110 associated with the first portable communication device 104. In addition, the verification is done after mapping of the real-time data obtained from the one or more hardware components 110 with the first set of data, the second set of data and the data available on the one or more web based platforms. In an example, the front camera of the first portable communication device 104 is triggered to capture the real-time image of the user. The real-time image of the user 102 is used to verify the user 102 by matching the real-time image with the image provided in the first set of data or the second set of data. Further, the real-time image of the user 102 is used to verify the user 102 by matching the real-time image with the image available on the one or more web-based platforms. In another example, the speaker and the mic of the first portable communication device 104 are triggered to perform voice related verification of the user 102. In yet another example, the speaker and the mic of the first portable communication device 104 are triggered to take voice statement from the user 102.

In an embodiment of the present disclosure, the financial processing system 114 provides the financial asset to the user 102 after the successful verification of the user 102. In addition, the at least one lender 120 provides the financial asset to the user 102 in the bank account of the user 102 provided in the third set of data. Further, the at least one lender 120 transfers the amount of financial asset to the user 102 through the one or more modes of transferring the financial asset. In an example, the one or more modes include transfer of financial asset through online mode, PayPal, bank draft and the like.

In an example, a user X wants a loan of Rs. 40,000 from the financial asset providing platforms. The user X access the financial asset providing platform through the smartphone and fills the first set of data, the second set of data and the third set of data. In addition, the financial asset providing platform verifies the user by using data of the user from other social network platforms. The financial asset providing platform creates a profile of the user X and maps the data of the profile of the user X with the stored data of the multiple lenders associated with the financial asset providing platform. Based on the mapping, the financial asset providing platform found lender A, lender B and lender C as the relevant lenders to lend money to the user X. Further, the financial asset providing platform found that the lender A can provide Rs. 50,000, lender B can provide Rs. 60,000 and lender C can provide Rs. 80,000. Thus, the financial asset providing platform recommend lender A to the user X after applying machine learning algorithms and optimization techniques on the data of the lender A, lender B and lender C. Further, the financial asset providing platform recommend the lender A to the user X for the benefit of lender B, and lender C for future lending purposes. As, the financial asset providing platform may recommend the lender B and the lender C to another user who needs high amount of loan than the loan required by the user X.

In an embodiment of the present disclosure, the financial processing system 114 shares information associated with repayment status of the financial asset by the user 102 availed from the lender 120 with other lenders. The information is shared for developing a reputation profile of the user 102 and allowing the user 102 to avail the financial asset from multiple lenders if the repayment of the financial asset has been done on time. In an embodiment of the present disclosure, the financial processing system 114 opens up more options to the user 102 for availing the financial asset. The options can be opened up based on a reputation of the user 102 with a lender from whom the user 102 availed the financial asset. The financial processing system 114 can allow the user 102 a provision to avail the financial asset from more number of lenders or banks when the user 102 applies for the loan again in the future. The financial processing system 114 will provide more options in the case of the user 102 paying the financial asset back in time to the lender from whom the user 102 availed the loan for the first time and so on.

In an embodiment of the present disclosure, the financial processing system 114 will keep on opening up more options for the user 102 in case of repayment of the loan on time. When the user 102 repays the loan on time to a corresponding lender, the financial processing system 114 passes the information regarding the repayment to other lenders so that the process for the same user can be simplified. In an embodiment of the present disclosure, the financial processing system 114 may create a whitelist of users who repay the loan on time and may share the whitelist across different lenders. In an embodiment of the present disclosure, the whitelist of users may help calculate a confidence score for each user.

In an embodiment of the present disclosure, the financial processing system 114 is associated with the server 116. In addition, the server 116 performs all the tasks related to the handling of the first portable communication device 104 and the second portable communication device 122. The server 116 receives the requests from the portable communication devices and processes these requests. In an example, the server 116 receives the request of the financial asset from the first portable communications device 104. The server 116 responds to the requests in an efficient manner. In an example, the server 116 is present inside the financial processing system 114. In another example, the server 116 is remotely located. In yet another embodiment of the present disclosure, the server 116 is a cloud server. The analysis of data, creating the profile of the user and storing data is done on the cloud server. In addition, the server 116 comprises the database 118. The database 118 is the storage location of all the data associated with the financial processing system 114. In an embodiment of the present disclosure, the financial processing system 114 stores the first set of data, the second set of data, the third set of data and the fourth set of data in the database 118 for future requirement.

In an embodiment of the present disclosure, the financial processing system 114 updates the first set of data, the second set of data, the third set of data and the fourth set of data. In addition, the financial processing system 114 updates all the data stored in the database 118 in real time.

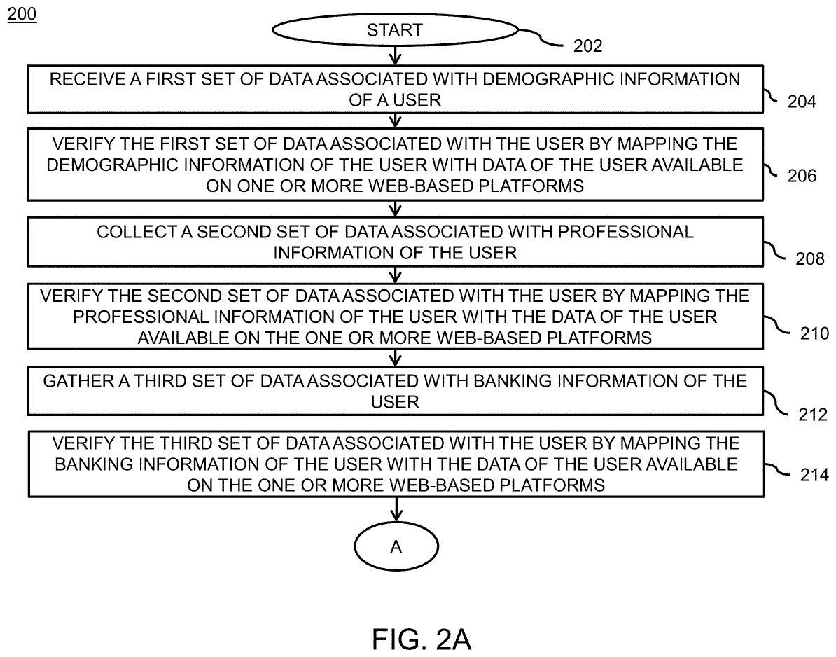

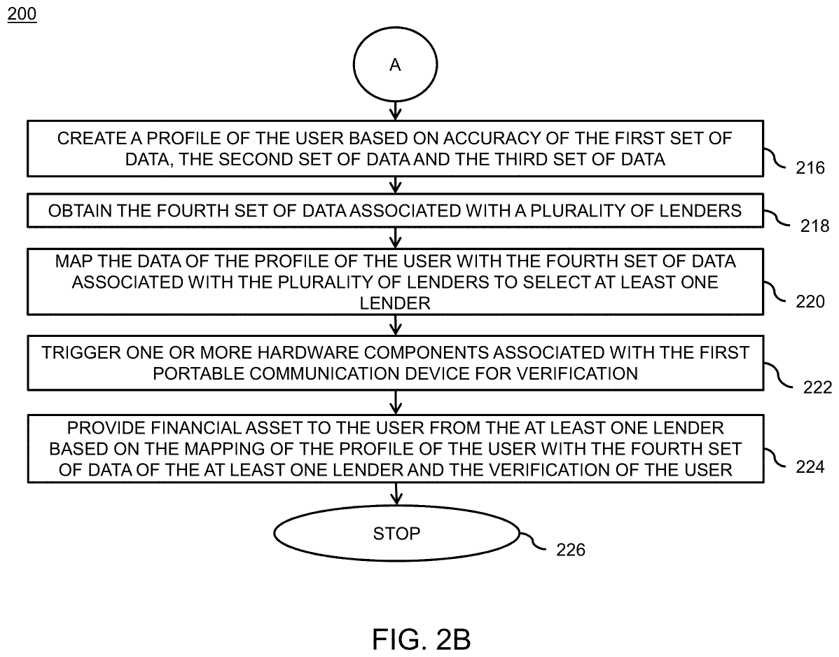

FIG. 2A and FIG. 2B illustrates a flowchart 200 of a method for providing the financial asset to the user 102 from the at least one lender 116 based on the profile of the user 102, in accordance with various embodiments of the present disclosure. It may be noted that to explain the process steps of the flowchart 200, references will be made to the system elements of FIG. 1. It may be noted that the flowchart 200 may have lesser or more number of steps.

The flowchart 200 initiates at step 202. Following step 202, at step 204 the financial processing system 110 receives the first set of data associated with the demographic information of the user 102. At step 206, the financial processing system 110 verifies the first set of data associated with the user 102 by mapping the demographic information of the user 102 with the data of the user 102 available on the one or more web-based platforms. At step 208, the financial processing system 110 collects the second set of data associated with the professional information of the user 102. At step 210, the financial processing system 110 verifies the second set of data associated with the user 102 by mapping the professional information of the user 102 with the data of the user 102 available on the one or more web-based platforms. At step 212, the financial processing system 110 gathers the third set of data associated with the banking information of the user. At step 214, the financial processing system 110 verifies the third set of data associated with the user 102 by mapping the banking information of the user 102 with the data of the user 102 available on the one or more web-based platforms. At step 216, the financial processing system 110 creates the profile of the user 102 based on accuracy of the first set of data, the second set of data and the third set of data. At step 218, the financial processing system 110 obtains the fourth set of data associated with the plurality of lenders. At step 220, the financial processing system 110 maps the data of the profile of the user with the fourth set of data associated with the plurality of lenders to select the at least one lender 116. At step 222, the financial processing system 110 triggers the one or more hardware components associated with the first portable communication device 104 for verification of the user 102. At step 224, the financial processing system 110 provides the financial asset to the user 102 from the at least one lender 116 based on the mapping of the profile of the user 102 with the fourth set of data of the at least one lender 116. In addition, the financial asset is provided to the user 102 after verification of the user 102. The flow chart 200 terminates at step 226.

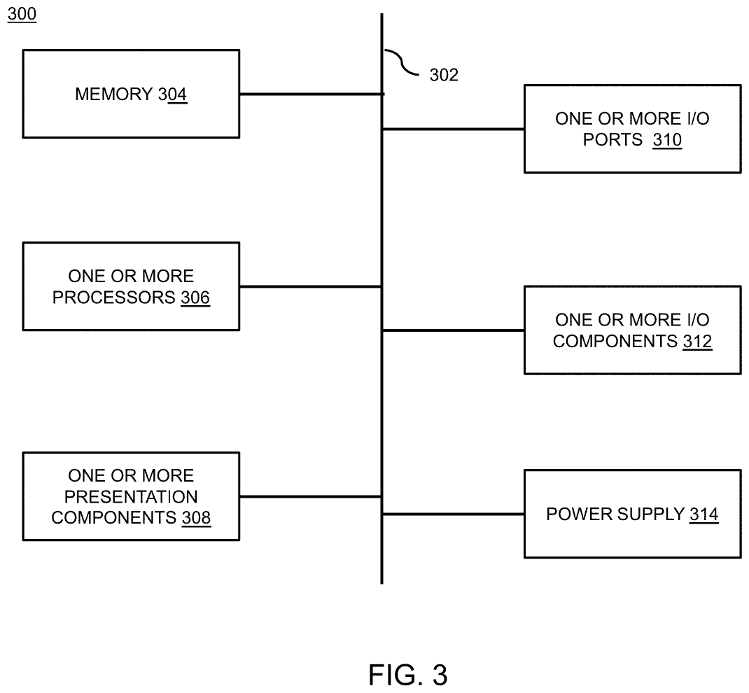

FIG. 3 illustrates a block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for sake of clarity, in reality, delineating various components is not so clear, and metaphorically, the lines would more accurately be grey and fuzzy. For example, one may consider a presentation component such as a display device to be an I/O component. Also, processors have memory. FIG. 3 is merely illustrative of an exemplary computing device 300 may be used in connection with one or more embodiments of the present disclosure. Distinction is not made between such categories as workstation, server, laptop, hand-held device and the like, as all are contemplated within the scope of FIG. 3 and reference to “the computing device 300.”

The computing device 300 typically includes a computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes the volatile and the nonvolatile, the removable and the non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies the computer-readable instructions, the data structures, the program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media includes wired media such as a wired network or direct-wired connection, and wireless media such as acoustic, RF, infrared and other wireless media. Combinations of any of the above should also be included within the scope of the computer readable media.

Memory 304 includes the computer-storage media in the form of volatile and/or nonvolatile memory. The memory 304 may be removable, non-removable, or a combination thereof. Exemplary hardware devices include solid-state memory, hard drives, optical-disc drives and the like. The computing device 300 includes the one or more processors to read data from various entities such as memory 304 or I/O components 312. The one or more presentation components 308 present data indications to a user or other device. Exemplary presentation components include a display device, speaker, printing component, vibrating component and the like. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device and the like.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed:

1. A computer-implemented method for a financial processing system for providing a financial asset to a user from at least one lender based on a profile of the user, the computer-implemented method comprising:
receiving, at the financial processing system with a processor, a first set of data associated with demographic information of the user, wherein the demographic information of the user is received when a signal generator circuitry embedded inside a first portable communication device generates a signal to open a first page on a first mobile application to receive inputs from the user regarding the demographic information;
verifying, at the financial processing system with the processor, the first set of data associated with the user by mapping the demographic information of the user with data of the user available on one or more web-based platforms, wherein the verification is done in real time;
collecting, at the financial processing system with the processor, a second set of data associated with professional information of the user, wherein the professional information of the user is collected when the signal generator circuitry embedded inside the portable communication device generates a signal to open a second page on the first mobile application to collect inputs from the user regarding the professional information;
verifying, at the financial processing system with the processor, the second set of data associated with the user by mapping the professional information of the user with the data of the user available on the one or more web-based platforms, wherein the verification is done in real time after collecting the second set of data from the user;
gathering, at the financial processing system with the processor, a third set of data associated with banking information of the user, wherein the banking information of the user is gathered when the signal generator circuitry embedded inside the portable communication device generates a signal to open a third page on the first mobile application to gather inputs from the user regarding the banking information of the user;
verifying, at the financial processing system with the processor, the third set of data associated with the user by mapping the banking information of the user with the data of the user available on the one or more web-based platforms, wherein the verification is done in real time;
creating, at the financial processing system with the processor, the profile of the user based on accuracy of the first set of data, the second set of data and the third set of data, wherein the accuracy of the first set of data, the second set of data and the third set of data is determined by verifying the first set of data, the second set of data and the third set of data in real time with the data of the user available on the one or more web-based platforms and wherein the profile of the user decides minimum amount of the financial asset rendered to the user;
obtaining, at the financial processing system with the processor, a fourth set of data associated with a plurality of lenders, wherein the fourth set of data is obtained in real time;
mapping, at the financial processing system with the processor, the data of the profile of the user with the fourth set of data of the plurality of lenders to select the at least one lender, wherein the at least one lender is selected from the plurality of lenders for providing the financial asset to the user;
triggering, at the financial processing system with the processor, one or more hardware components associated with the first portable communication device by the signal generator circuitry embedded inside the first portable communication device, wherein the one or more hardware components is triggered for verification of the user; and
providing, at the financial processing system with the processor, the financial asset to the user from the at least one lender based on the mapping of the profile of the user with the fourth set of data of the at least one lender and based on the verification of the user.

2. The computer-implemented method as recited in claim 1, wherein the first set of data comprises the demographic information of the user, and wherein the demographic information comprises name, last name, age, gender, father name, mother name, mobile number, address, e-mail address, education, nationality, number and type of devices associated with the user.

3. The computer-implemented method as recited in claim 1, wherein the second set of data associated with the professional information of the user and wherein the professional information comprises occupation, company details, salary details, experience, pan card details, aadhaar card details, passport availability.

4. The computer-implemented method as recited in claim 1, wherein the third set of data associated with the banking details of the user, wherein the banking details comprises bank account details, number of bank accounts associated with the user, number of credit cards and debit cards accessed by the user, amount of the financial asset required by the user, preference of the mode of transfer of the financial asset from the at least one lender, preference of the user in rate of interest and time duration of repayment of the financial asset.

5. The computer-implemented method as recited in claim 1, wherein the fourth set of data associated with the plurality of lenders comprises the information regarding rate of interest, time, minimum amount of the financial asset rendered by the plurality of lenders, one or more terms and conditions of the plurality of lenders to provide the financial asset.

6. The computer-implemented method as recited in claim 1, wherein the one or more hardware components are triggered to obtain real-time data from the user for verification of the user and wherein the one or more hardware components comprise a front camera, rear camera, mic and speaker of the portable communication device.

7. The computer-implemented method as recited in claim 1, further comprising, analyzing, at the financial processing system with the processor, the first set of data, the second set of data and the third set of data with past user data stored in a database, wherein the past user data is used to identify user pattern, wherein the user pattern is identified to analyze user behavior for repayment of the financial asset, and wherein the analyzing is done by using machine learning algorithms in real time.

8. The computer-implemented method as recited in claim 1, further comprising, storing, at the financial processing system with the processor, the first set of data, the second set of data, the third set of data and the fourth set of data, wherein the storing is done in real time.

9. The computer-implemented method as recited in claim 1, further comprising updating, at the financial processing system with the processor, the first set of data, the second set of data, the third set of data and the fourth set of data, wherein the updating is done in real time.

10. The computer-implemented method as recited in claims 1, wherein the one or more hardware components are triggered after acceptance of request by the at least one lender to provide the financial asset to the user.

11. A computer system comprising:
one or more processors; and
a memory coupled to the one or more processors, the memory for storing instructions which, when executed by the one or more processors, cause the one or more processors to perform a method for providing financial asset to a user from at least one lender based on a profile of the user, the method comprising:
receiving, at a financial processing system, a first set of data associated with demographic information of the user, wherein the demographic information of the user is received when a signal generator circuitry embedded inside a portable communication device generates a signal to open a first page on a first mobile application to receive inputs from the user regarding the demographic information;
verifying, at the financial processing system, the first set of data associated with the user by mapping the demographic information of the user with data of the user available on one or more web-based platforms, wherein the verification is done in real time;
collecting, at the financial processing system, a second set of data associated with professional information of the user, wherein the professional information of the user is collected when the signal generator circuitry embedded inside the portable communication device generates a signal to open a second page on the first mobile application to collect inputs from the user regarding the professional information;
verifying, at the financial processing system, the second set of data associated with the user by mapping the professional information of the user with the data of the user available on the one or more web-based platforms, wherein the verification is done in real time after collecting the second set of data from the user;
gathering, at the financial processing system, a third set of data associated with banking information of the user, wherein the banking information of the user is gathered when the signal generator circuitry embedded inside the portable communication device generates a signal to open a third page on the first mobile application to gather inputs from the user regarding the banking information of the user;
verifying, at the financial processing system, the third set of data associated with the user by mapping the banking information of the user with the data of the user available on the one or more web-based platforms, wherein the verification is done in real time;
creating, at the financial processing system, the profile of the user based on accuracy of the first set of data, the second set of data and the third set of data, wherein the accuracy of the first set of data, the second set of data and the third set of data is determined by verifying the first set of data, the second set of data and the third set of data in real time with the data of the user available on the one or more web-based platforms and wherein the profile of the user is used to decide minimum amount of the financial asset rendered to the user;
obtaining, at the financial processing system, the fourth set of data associated with a plurality of lenders, wherein the fourth set of data is obtained in real time;
mapping, at the financial processing system, the data of the profile of the user with the fourth set of data of the plurality of lenders to select the at least one lender, wherein the at least one lender is selected from the plurality of lenders for providing the financial asset to the user;
a signal generator circuitry embedded inside the first portable communication device to trigger one or more hardware components associated with the first portable communication device, wherein the one or more hardware components are triggered for verification of the user; and
providing, at the financial processing system, the financial asset to the user from the at least one lender based on the mapping of the profile of the user with the fourth set of data of the at least one lender and based on the verification of the user.

12. The computer system as recited in claim 11, wherein the first set of data comprises the demographic information of the user, wherein the demographic information comprises name, last name, age, gender, father name, mother name, mobile number, address, e-mail address, education, nationality, number and type of devices associated with the user.

13. The computer system as recited in claim 11, wherein the second set of data associated with the professional information of the user, wherein the professional information comprises occupation, company details, salary details, experience, pan card details, aadhaar card details, passport availability.

14. The computer system as recited in claim 11, wherein the third set of data associated with the banking details of the user, wherein the banking details comprises bank account details, number of bank accounts associated with the user, number of credit cards and debit cards accessed by the user, amount of the financial asset required by the user, preference of the mode of transfer of the financial asset from the at least one lender, preference of the user in rate of interest and time duration of repayment of the financial asset.

15. The computer system as recited in claim 11, wherein the fourth set of data associated with the plurality of lenders comprises the information regarding rate of interest, time, minimum amount of the financial asset rendered by the plurality of lenders, one or more terms and conditions of the plurality of lenders to provide financial asset.

16. The computer system as recited in claim 11, wherein the one or more hardware components are triggered to obtain real-time data from the user for verification of the user and wherein the one or more hardware components comprise a front camera, rear camera, mic and speaker of the portable communication device.

17. The computer system as recited in claim 11, further comprising, analyzing, at the financial processing system, the first set of data, the second set of data and the third set of data with past user data stored in a database, wherein the past user data is used to identify user pattern, wherein the user pattern is identified to analyze user behavior for repayment of the financial asset, wherein the analyzing is done by using machine learning algorithms in real time.

18. The computer system as recited in claim 11, further comprising, storing, at the financial processing system, the first set of data, the second set of data, the third set of data and the fourth set of data, wherein the storing is done in real time.

19. The computer system as recited in claim 11, further comprising updating, at the financial processing system, the first set of data, the second set of data, the third set of data and the fourth set of data, wherein the updating is done in real time.

20. A computer-readable storage medium encoding computer executable instructions that, when executed by at least one processor, performs a method for providing financial asset to a user from at least one lender based on a profile of the user, the method comprising:
receiving, at a computing device, a first set of data associated with demographic information of the user, wherein the demographic information of the user is received when a signal generator circuitry embedded inside a portable communication device generates a signal to open a first page on a first mobile application to receive inputs from the user regarding the demographic information;
verifying, at the computing device, the first set of data associated with the user by mapping the demographic information of the user with data of the user available on one or more web-based platforms, wherein the verification is done in real time;
collecting, at the computing device, a second set of data associated with professional information of the user, wherein the professional information of the user is collected when the signal generator circuitry embedded inside the portable communication device generates a signal to open a second page on the first mobile application to collect inputs from the user regarding the professional information;
verifying, at the computing device, the second set of data associated with the user by mapping the professional information of the user with the data of the user available on the one or more web-based platforms, wherein the verification is done in real time after collecting the second set of data from the user;
gathering, at the computing device, a third set of data associated with banking information of the user, wherein the banking information of the user is gathered when the signal generator circuitry embedded inside the portable communication device generates a signal to open a third page on the first mobile application to gather inputs from the user regarding the banking information of the user;
verifying, at the computing device, the third set of data associated with the user by mapping the banking information of the user with the data of the user available on the one or more web-based platforms, wherein the verification is done in real time;
creating, at the computing device, the profile of the user based on accuracy of the first set of data, the second set of data and the third set of data, wherein the accuracy of the first set of data, the second set of data and the third set of data is determined by verifying the first set of data, the second set of data and the third set of data in real time with the data of the user available on the one or more web-based platforms and wherein the profile of the user is used to decide minimum amount of the financial asset rendered to the user;
obtaining, at the computing device, the fourth set of data associated with a plurality of lenders, wherein the fourth set of data is obtained in real time;
mapping, at the computing device, the data of the profile of the user with the fourth set of data of the plurality of lenders to select the at least one lender, wherein the at least one lender is selected from the plurality of lenders for providing the financial asset to the user;
triggering, at the computing device, one or more hardware components associated with the first portable communication device by a signal generator circuitry embedded inside the first portable communication device, wherein the one or more hardware components are triggered for verification of the user; and
providing, at the computing device, the financial asset to the user from the at least one lender based on the mapping of the profile of the user with the fourth set of data of the at least one lender and based on the verification of the user.
